(19) United States
(12) Patent Application Publication
(10) Pub. No.: US 2026/0202707 A1
(43) Pub. Date: Jul. 16, 2026

(54) LIQUID CRYSTAL DISPLAY APPARATUS

(71) Applicant: LG Display Co., Ltd., Seoul (KR)

(72) Inventors: Ju Hoon JANG, Paju-si (KR); Hoon KANG, Paju-si (KR); Dong Yeon KIM, Paju-si (KR)

(73) Assignee: LG Display Co., Ltd., Seoul (KR)

(21) Appl. No.: 19/450,526

(22) Filed: Jan. 15, 2026

(30) Foreign Application Priority Data
Jan. 16, 2025 (KR) 10-2025-0006697

(51) Int. Cl. G02F 1/1362; G02B 30/27; G02B 30/33

(52) U.S. Cl. CPC G02F 1/136286; G02B 30/27; G02B 30/33; G02F 1/136209; G02F 1/136222

(57) ABSTRACT

A liquid crystal display apparatus can include gate lines and data lines intersecting with each other in a matrix type to define pixel areas on a first substrate, a common electrode disposed in the pixel areas, a common electrode compensation pattern directly contacting the common electrode at positions overlapping the gate lines and the data lines, and a pixel electrode disposed on the common electrode compensation pattern. A position of the common electrode compensation pattern is shifted by a horizontal pitch of one subpixel between adjacent pixel rows of the pixel areas.

### CROSS-REFERENCE TO RELATED APPLICATIONS

This application claims priority to Korean Patent Application No. 10-2025-0006697, filed in the Republic of Korea on January 16, 2025, which is hereby incorporated by reference as if fully set forth herein.

### BACKGROUND

### Field of the Invention

The present disclosure relates to a liquid crystal display apparatus.

### Discussion of the Related Art

Liquid crystal display (LCD) apparatuses drive liquid crystal molecules included in a liquid crystal layer, based on a voltage difference between a pixel electrode and a common electrode, and thus, control the amount of light passing through the liquid crystal layer.

Since the common electrode overlaps other signal lines in a display panel, a common voltage applied to the common electrode fluctuates due to a coupling effect with display signals. Various methods are being attempted for decreasing a sheet resistance of the common electrode and a ripple of the common voltage, but there is a picture issue such as an undesired black vertical band being recognized.

Such a problem can be move evident when an optical module for implementing a two-dimensional (2D) or three-dimensional (3D) image is added to the display panel.

### SUMMARY OF THE DISCLOSURE

To overcome the aforementioned and other problems of the related art, the present disclosure can provide a liquid crystal display (LCD) apparatus which can prevent or minimize a fluctuation of a common voltage and can solve or address a picture issue which can be caused by a black vertical band.

To achieve these objects and other advantages and in accordance with the purpose of the disclosure, as embodied and broadly described herein, a liquid crystal display apparatus includes gate lines and data lines intersecting with each other in a matrix type to define pixel areas, on a first substrate; a common electrode disposed in the pixel areas; a common electrode compensation pattern directly contacting the common electrode at positions overlapping the gate lines and the data lines; and a pixel electrode disposed on the common electrode compensation pattern, wherein a position of the common electrode compensation pattern is shifted by a horizontal pitch of one subpixel between adjacent pixel rows of the pixel areas.

According to aspects of the present disclosure, the common electrode compensation pattern can include first mesh patterns extending in a horizontal direction to overlap the gate lines; and second mesh patterns extending in a vertical direction to overlap some of the data lines and connected to the first mesh patterns, and positions of the second mesh patterns can be shifted by a horizontal pitch of one subpixel between the adjacent pixel rows.

According to aspects of the present disclosure, with respect to positions of the second mesh patterns disposed in an n^{th} pixel row, positions of the second mesh patterns disposed in an (n+1)^{th} pixel row can be shifted by the horizontal pitch of the one subpixel in a right direction, where n can be a real number such as a positive integer.

According to aspects of the present disclosure, with respect to positions of the second mesh patterns disposed in an n^{th} pixel row, positions of the second mesh patterns disposed in an (n+1)^{th} pixel row can be shifted by the horizontal pitch of the one subpixel in a left direction.

According to aspects of the present disclosure, the common electrode compensation pattern can further include third mesh patterns disposed between adjacent second mesh patterns in a same pixel row and partially overlapping the other data lines, and in a same pixel row, a length of each of the third mesh patterns can be less than a length of each of the second mesh patterns.

According to aspects of the present disclosure, in a same pixel row, a length of each of the third mesh patterns can be 1/3 or less of a length of each of the second mesh patterns.

According to aspects of the present disclosure, a line width of the common electrode compensation pattern can be less than a line width of each of the gate lines and the data lines.

According to aspects of the present disclosure, the common electrode can include a transparent conductive material, and the common electrode compensation pattern can include an opaque conductive material.

According to aspects of the present disclosure, the liquid crystal display apparatus can further include a black matrix pattern disposed on a second substrate opposite-bonded to the first substrate; and color filters disposed on the black matrix pattern, wherein the common electrode compensation pattern can be disposed at a position overlapping the black matrix pattern.

According to aspects of the present disclosure, the liquid crystal display apparatus can further include a plurality of lenses disposed on a display panel including the first substrate and the second substrate opposite-bonded to each other and configured to represent a two-dimensional (2D) image or a three-dimensional (3D) image, based on light incident from the display panel.

In the LCD apparatus according to embodiments of the present disclosure, a common electrode compensation pattern directly contacting a common electrode can be disposed in common at positions overlapping gate lines and data lines, and a position of the common electrode compensation pattern can be shifted by a horizontal pitch of one subpixel between adjacent pixel rows of pixel areas, thereby preventing a fluctuation of a common voltage and solving a picture issue caused by a black vertical band.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIGS. 1 and 2 are diagrams schematically illustrating a liquid crystal display (LCD) apparatus according to an embodiment of the present disclosure;

FIG. 3 is a diagram illustrating a configuration of a first substrate of a display panel according to an embodiment of the present disclosure;

FIG. 4 is a diagram illustrating a cross-sectional surface taken along line A-A' of FIG. 3 according to an embodiment of the present disclosure;

FIG. 5 is a diagram illustrating an example where a multi-view is implemented in an LCD apparatus according to an embodiment of the present disclosure;

FIG. 6 is a diagram illustrating a placement example of a common electrode compensation pattern;

FIG. 7 is a diagram illustrating a mechanism where a black vertical band occurs in an example of FIG. 6;

FIG. 8 is a diagram illustrating another placement example of a common electrode compensation pattern;

FIG. 9 is a diagram illustrating another placement example of a common electrode compensation pattern; and

FIG. 10 is a diagram illustrating a mechanism where the occurrence of a black vertical band is prevented in an example of FIGS. 8 and 9 according to an embodiment of the present disclosure.

### DETAILED DESCRIPTION OF THE DISCLOSURE

Hereinafter, the present disclosure will be described more fully with reference to the accompanying drawings, in which example embodiments of the disclosure are shown. The disclosure may, however, be embodied in many different forms and should not be construed as being limited to the embodiments set forth herein; rather, these embodiments are provided so that this disclosure will be thorough and complete, and will fully convey the concept of the disclosure to those skilled in the art.

Like reference numerals refer to like elements. Further, a thickness, a ratio, and a dimension of each element described herein are illustrated to be partially enlarged or reduced for convenience of effective description. Each element illustrated in the drawings of the present disclosure can have a scale which differs from a real scale, for convenience of description, but is not limited to a scale illustrated in the drawings.

In the present disclosure, when an arbitrary element (or a region, a layer, a portion, etc.) is described as “being on”, "connected", or "coupled", this can denote that the arbitrary element can be directly connected/coupled to another element, or a third element can be disposed therebetween.

The term "and/or" can include all of one or more combinations capable of being defined by relevant elements.

Terms like a first and a second can be used to describe various elements, but the elements should not be limited by the terms. The terms can be used only as object for distinguishing an element from another element. For example, without departing from the spirit and scope of the inventive concept, a first element can be referred to as a second element, and similarly, the second element can be referred to as the first element. The terms of a singular form can include plural forms unless referred to the contrary. These terms may not define order or sequence.

The terms such as "under", "below", "on", and "above" can be used to describe a correlation between elements illustrated in the drawings. The terms can be a relative concept and can be described with respect to a direction illustrated in the drawings. For example, unless "just" or "direct" is used, one or more other elements can be disposed between two elements. Spatially relative terms such as “below”, “beneath”, “lower”, “above”, and “upper” can be used herein for easily describing a relationship between one device or element and other devices or elements as illustrated in the drawings. Therefore, for example, "under” and "lower" can be opposite to "on" and "upper" with respect to a first element.

It should be understood that spatially relative terms are terms including different orientations of elements in use or operation, in addition to the orientation illustrated in the drawings. For example, if a device in the drawings is turned over, elements described as being on the “below” or “beneath” sides of other elements can be placed on “above” sides of the other elements. Therefore, the example term “lower” can include both orientations of “lower” and “upper”. Likewise, the example term such as “above” or “upper” can include both orientations of above and below.

It should be understood that the meaning of “include,” “comprise,” “including,” or “comprising,” specifies a feature, a region, a number, a step, a process, an element and/or a component, but does not exclude other features, regions, numbers, steps, processes, elements and/or components. Further, the term “can” fully encompasses all the meanings and coverages of the term “may” and vice versa.

Features of various embodiments of the present disclosure can be partially or overall coupled to or combined with each other and can be variously inter-operated with each other and driven technically as those skilled in the art can sufficiently understand. The embodiments of the present disclosure can be carried out independently of each other, or can be carried out together in co-dependent relationship.

Now, various embodiments of the present disclosure will be described referring to the figures. All the components of each display device/apparatus according to all embodiments of the present disclosure are operatively coupled and configured.

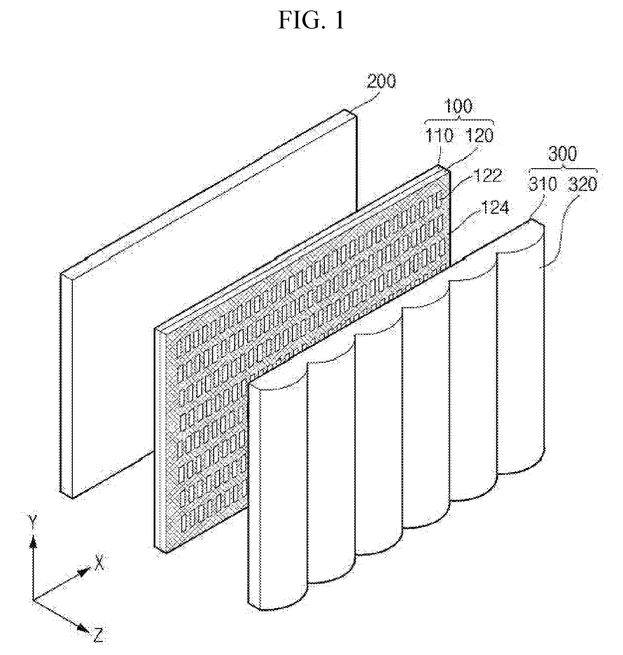

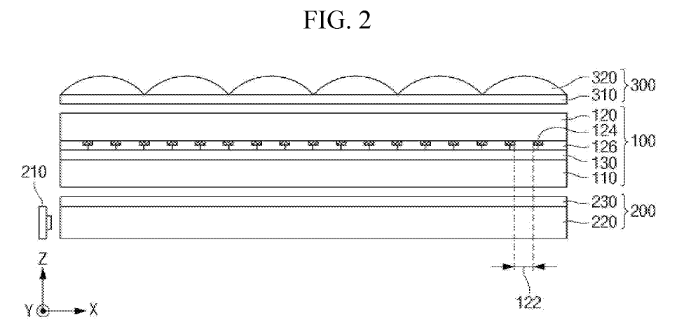

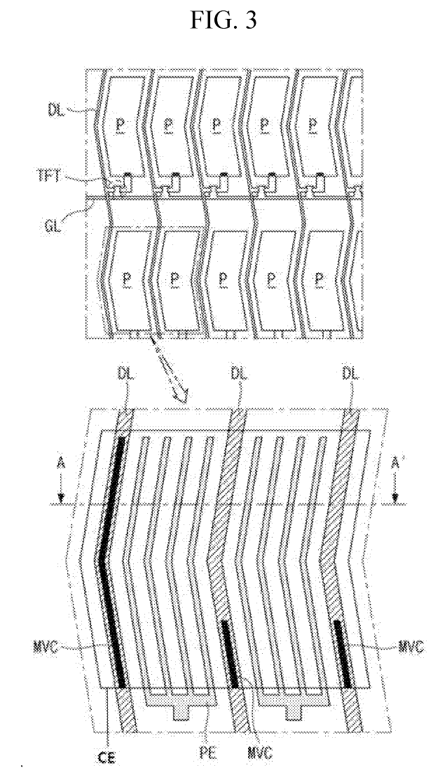

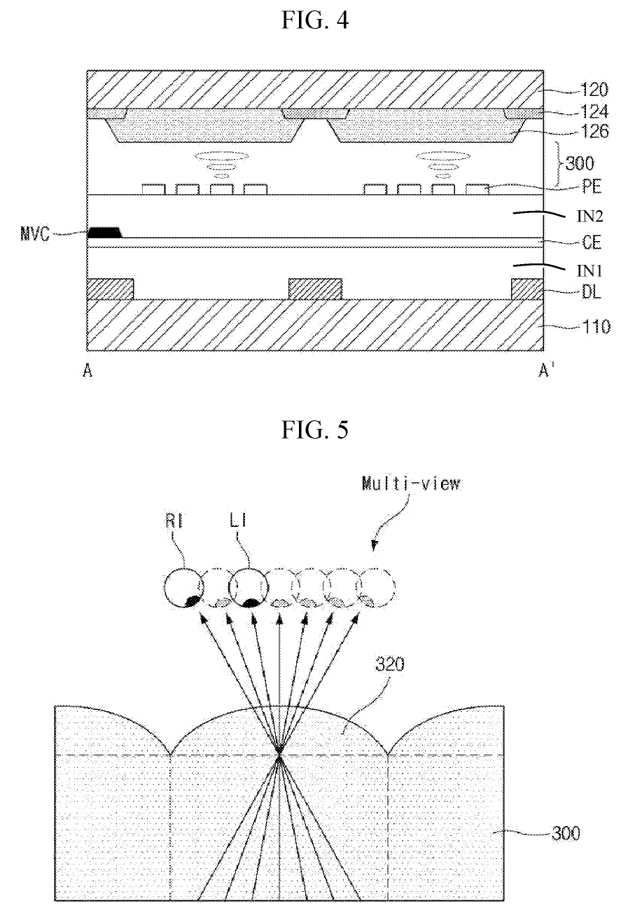

FIGS. 1 and 2 are diagrams schematically illustrating a liquid crystal display (LCD) apparatus according to an embodiment of the present disclosure. FIG. 3 is a diagram illustrating a configuration of a first substrate of a display panel according to an embodiment of the present disclosure. FIG. 4 is a diagram illustrating a cross-sectional surface taken along line A-A' of FIG. 3 according to an embodiment of the present disclosure. FIG. 5 is a diagram illustrating an example where a multi-view is implemented in an LCD apparatus according to an embodiment of the present disclosure.

Referring to FIGS. 1 to 4, the LCD apparatus according to an embodiment of the present disclosure can include a display panel 100, a backlight unit 200, and a viewing angle control unit 300.

The display panel 100 can display an image by using a plurality of subpixels P. The display panel 100 can include a first substrate 110 and a second substrate 120, which are opposite-bonded to each other with a liquid crystal layer 130 therebetween. The display panel 100 can have a length in the X-axis direction, a width in the Y-axis direction, and a thickness in the Z-axis direction. In addition, the X-axis direction can mean a longitudinal direction or a horizontal direction, the Y-axis direction can mean a width direction or a vertical direction, and the Z-axis direction can mean a stacking direction, or a thickness direction. Here, the X-axis direction, the Y-axis direction, and the Z-axis direction can be perpendicular to each other, but can also be different directions that are not perpendicular to each other.

The first substrate 110 can be a thin film transistor array substrate including thin film transistors, and as illustrated in FIG. 3, can include a plurality of gate lines GL, a plurality of data lines DL, a thin film transistor TFT, and a plurality of subpixels P.

The plurality of gate lines GL and the plurality of data lines DL can be arranged to intersect with each other on the first substrate 110 and can thus define a plurality of pixel areas. In other words, the plurality of gate lines GL and the plurality of data lines DL can intersect with each other in a matrix type on the first substrate 110 to define the pixel areas which include red (R), green (G), and blue (B) subpixels.

The thin film transistor TFT can be formed in a transistor region of each pixel area, and can be turned on based on a gate signal supplied by a corresponding gate line GL to supply a data signal, supplied by a corresponding data line DL, to a pixel electrode PE. The thin film transistor TFT can include a gate electrode, a semiconductor layer, a source electrode, and a drain electrode. The thin film transistor TFT can be configured in a bottom gate structure where the gate electrode is disposed under the semiconductor layer, or can be configured in a top gate structure where the gate electrode is disposed on the semiconductor layer.

The plurality of subpixels P can include an R subpixel displaying red, a G subpixel displaying green, and a B subpixel displaying blue, but are not limited thereto. The plurality of subpixels P can further include a W subpixel displaying white.

Each of the plurality of subpixels P can include a pixel electrode PE , which is connected to the thin film transistor TFT and a common electrode CE.

At least one insulation layer IN1 can be disposed on the data lines DL, and a common electrode CE can be disposed on the insulation layer IN1. The common electrode CE can form a lateral electric field along with the pixel electrode PE to drive liquid crystal molecules of the liquid crystal layer 130. The common electrode CE can include a transparent conductive material such as indium tin oxide (ITO) or indium zinc oxide (IZO). The common electrode CE can have a sheet shape and can be formed as a partial common plate on a front-side surface of the first substrate 110.

A common voltage compensation pattern MVC can be disposed on the common electrode CE and can directly contact the common electrode CE. The common voltage compensation pattern MVC can directly contact the common electrode CE at positions overlapping the gate lines GL and the data lines DL. The common voltage compensation pattern MVC can reduce a ripple of a common voltage and a sheet resistance of the common electrode CE.

The common voltage compensation pattern MVC, unlike the common electrode CE, can include an opaque metal and can be formed of metal which is higher in conductivity than a transparent conductive material. Further, the common voltage compensation pattern MVC can include a conductive organic material which is high in electrical conductivity. In this case, the reflection of light can be prevented, and an aperture ratio of an LCD apparatus can be enhanced.

At least one insulation layer IN2 can be disposed on the common voltage compensation pattern MVC (also referred to as a common electrode compensation pattern) and the common electrode CE, and the pixel electrode PE can be disposed on the insulation layer IN2. The pixel electrode PE can be connected to a source electrode or a drain electrode of the thin film transistor TFT and can form an electric field in the liquid crystal layer 130, based on a data signal supplied from the thin film transistor TFT. The pixel electrode PE can include a plurality of finger portions to have a fork shape. To secure an aperture ratio, the pixel electrode PE can include a transparent conductive material such as ITO or IZO.

The finger portions of the pixel electrode PE can be disposed on the common electrode CE having a sheet shape with at least one insulation layer IN2 therebetween.

The pixel electrode PE can be formed in a bending shape, and thus, the subpixel P can be formed in a multi-domain structure which is divided into a first domain and a second domain. In the multi-domain structure, an alignment direction of liquid crystal can be differently controlled in the first domain and the second domain. Accordingly, a color shift and a viewing angle can be improved.

A view map, which is set based on the number of multi-views, can be allocated to each of the plurality of subpixels P.

The second substrate 120 can be a color filter array substrate which includes color filters 126. As illustrated in FIGS. 2 and 4, a black matrix 124 and the color filter 126 can be disposed on the second substrate 120.

Opening regions 122 of the plurality of subpixels P can be defined by the black matrixes 124. The black matrix 124 can include a light-blocking material, and for example, can include a black resin.

The color filter 126 can be provided in the opening region 122 which is not covered by the black matrix 124. The color filter 126 can include a red color filter, a green color filter, and a blue color filter.

The display panel 100 can supply a data signal, supplied from a panel driver, to a corresponding subpixel P to form an electric field in the liquid crystal layer 130, and thus, can adjust a transmittance of light incident from the backlight unit 200. Accordingly, the display panel 100 can display an image based on the view map allocated to each subpixel P.

The backlight unit 200 can be disposed on a backside surface of the display panel 100 and can irradiate light onto the display panel 100. The backlight unit 200 can include a light source 210, a light guide plate 220 which guides a light from a light source 210 in a direction toward the display panel 100, and an optical sheet 230 which is disposed on the light guide plate 220 and enhances light efficiency. The backlight unit 200 can be implemented as a direct type or an edge type. Light sources 210 of the backlight unit 200 can include one light source or two or more kinds of light sources among a hot cathode fluorescent lamp (HCFL), a cold cathode fluorescent lamp (CCFL), an external electrode fluorescent lamp (EEFL), a light emitting diode (LED), and an organic light emitting diode (OLED).

The viewing angle control unit 300 can be disposed on the display panel 100 and can include a base film 310 and a plurality of lenses 320 provided on an upper surface of the base film 310. The plurality of lenses 320 can be formed to be convex from the upper surface of the base film 310 and can extend lengthwise in a vertical direction. For example, the plurality of lenses 320 can each include a cross-sectional surface of a convex lens having a semicircular shape or a certain curvature. The plurality of lenses 320 can each be a lenticular lens, but are not limited thereto. Each of the plurality of lenses 320 can be implemented as a switchable lens.

The viewing angle control unit 300 can divide an image, displayed in the plurality of subpixels P, into a plurality of views (or a plurality of viewing zones). In detail, as illustrated in FIG. 5, the viewing angle control unit 300 can control light from each of the plurality of subpixels P, and thus, can form a viewing zone at an optimal viewing distance. The viewing zone can include a plurality of views. Each of the plurality of views can have a diamond shape. A width of each of the plurality of views can be formed to be less than a binocular interval of a person, so as to see different images with both eyes of a person.

The viewing angle control unit 300 can divide an image, displayed in the plurality of subpixels P, into a plurality of views by using the plurality of lenses 320. The viewing angle control unit 300 can divide an image, displayed in the plurality of subpixels P included in the lens 320, into a plurality of views corresponding to the view map, and thus, can enable a viewer to view a three-dimensional (3D) image in a plurality of viewing zones. The viewer can feel a sense of three dimensions, based on a binocular disparity between a left-eye image L1 recognized with a left eye and a right-eye image R1 recognized with a right eye in a predetermined viewing zone.

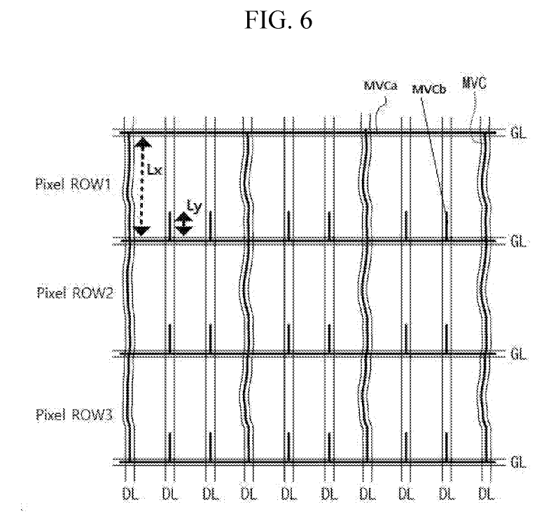

FIG. 6 is a diagram illustrating a placement example of a common electrode compensation pattern.

Referring to FIG. 6, the common electrode compensation pattern can directly contact a common electrode at positions overlapping gate lines GL and data lines DL. The common electrode compensation pattern can include first mesh patterns MVCa which extend in a horizontal direction to overlap the gate lines GL and second mesh patterns MVC which extend in a vertical direction to overlap some of the data lines DL and are connected to the first mesh patterns MVCa.

The common electrode compensation pattern can directly contact the common electrode to decrease a sheet resistance of the common electrode and a ripple of a common voltage. When only a common voltage stabilization effect is considered, the common electrode compensation pattern can be disposed in a full-mesh form at the positions overlapping the gate lines GL and the data lines DL. According to the common electrode compensation pattern having a full-mesh form, a contact area with the common electrode can increase, and thus, the common voltage stabilization effect can be enhanced in proportion thereto.

However, according to the common electrode compensation pattern having a full-mesh form, a level of luminance non-uniformity of a display panel can increase due to a light reflection effect caused by the common electrode compensation pattern.

The common voltage stabilization effect and the light reflection effect can have a trade-off relationship therebetween. As a placement area of the common electrode compensation pattern enlarges to be close to a full-mesh form, the common voltage stabilization effect can be improved, and the light reflection effect can be degraded. On the other hand, as the placement area of the common electrode compensation pattern decreases, the light reflection effect can be improved, and the common voltage stabilization effect can be degraded.

Therefore, as in FIG. 6, a common electrode compensation pattern having a semi-mesh form can be considered.

The common electrode compensation pattern having a semi-mesh form can include the first mesh patterns MVCa which extend in a horizontal direction to overlap the gate lines GL, the second mesh patterns MVC which extend in a vertical direction to overlap some of the data lines DL and are connected to the first mesh patterns MVCa, and third mesh patterns MVCb which are disposed between adjacent second mesh patterns MVC in the same pixel row and partially overlap the other data lines DL.

In the same pixel row, a length Ly of each of the third mesh patterns MVCb can be formed to be less than a length Lx of each of the second mesh patterns MVC, and thus, a semi-mesh form can be set instead of a full-mesh form, whereby the light reflection effect can decrease in proportion thereto.

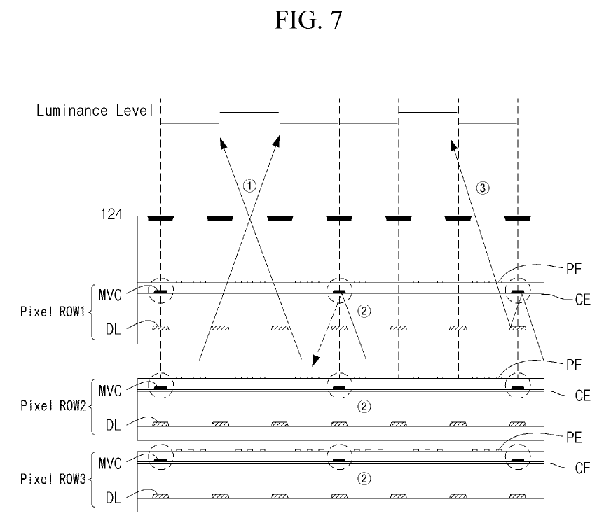

FIG. 7 is a diagram illustrating a mechanism where a black vertical band occurs in an example of FIG. 6.

In a case of FIG. 6, because a semi-mesh form of the common electrode compensation pattern is identically repeated in all pixel rows, there can be a limitation in decreasing a light reflection effect. For example, when a semi-mesh form of the common electrode compensation pattern is identically repeated in all pixel rows, a black vertical band can occur as in FIG. 7.

In FIG. 7, ① represents a path of light which is output through a region where a common electrode compensation pattern MVC is not provided. Luminance of light which is output through the region where the common electrode compensation pattern MVC is not provided can be relatively high.

In FIG. 7, ② represents a path of light reflected by the common electrode compensation pattern MVC. Luminance of light which is output after being reflected by the common electrode compensation pattern MVC can be relatively low.

In FIG. 7, ③ represents a path of light, which is output after light is primarily reflected by the common electrode compensation pattern MVC and is re-reflected by a data line DL. Luminance of light, which is output after light is primarily reflected by the common electrode compensation pattern MVC and is re-reflected by a data line DL can be relatively high.

According to FIGS. 6 and 7, because a semi-mesh form of the common electrode compensation pattern is identically repeated in all pixel rows, per-position luminance non-uniformity may not be offset, and constructive interference can be applied to each other. As a result, in ① and ③, luminance can be relatively high, and in ②, luminance can be relatively low, and thus, a luminance non-uniformity phenomenon recognized in a vertical band shape can occur.

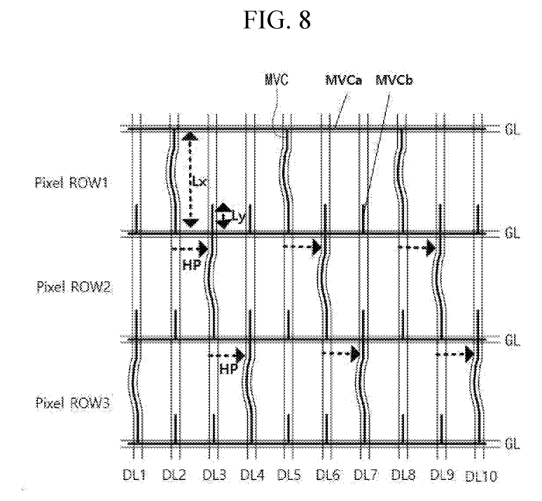

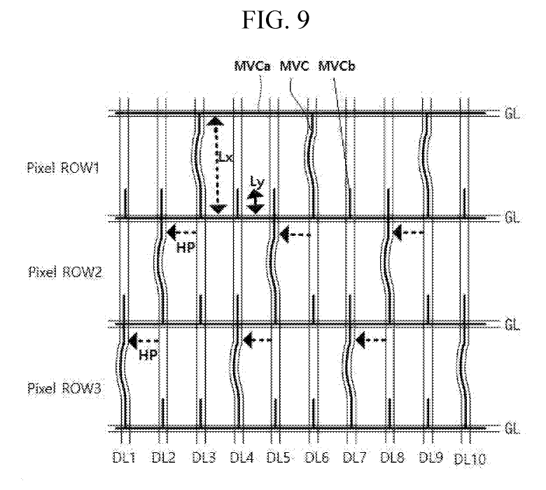

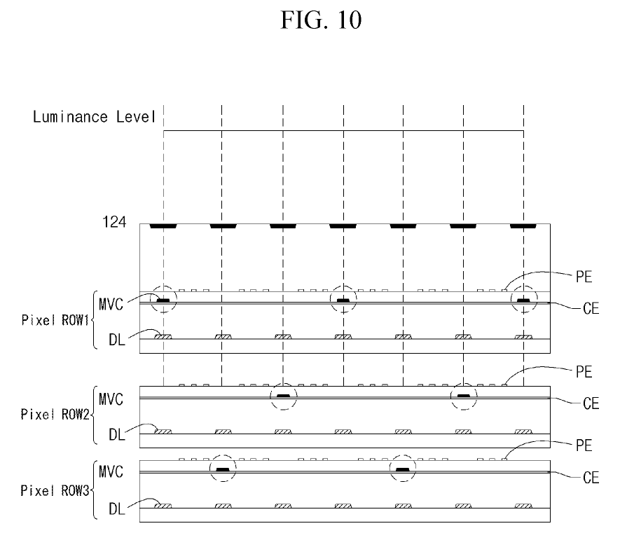

FIG. 8 is a diagram illustrating another placement example of a common electrode compensation pattern. FIG. 9 is a diagram illustrating another placement example of a common electrode compensation pattern. FIG. 10 is a diagram illustrating a mechanism where the occurrence of a black vertical band is prevented in an example of FIGS. 8 and 9.

Referring to FIGS. 8 and 9, a common electrode compensation pattern according to an embodiment of the present disclosure can be disposed in a semi-mesh form to directly contact a common electrode at positions overlapping gate lines GL and data lines DL, and a position of the common electrode compensation pattern having a semi-mesh form can be shifted by a horizontal pitch HP of one subpixel between adjacent pixel rows of pixel areas, thereby minimizing per-position luminance non-uniformity.

In detail, the common electrode compensation pattern according to an embodiment of the present disclosure can include first mesh patterns MVCa which extend in a horizontal direction to overlap the gate lines GL and second mesh patterns MVC which extend in a vertical direction to overlap some of the data lines DL and are connected to the first mesh patterns MVCa, and a position of each of the second mesh patterns MVC can be shifted by a horizontal pitch HP of one subpixel between adjacent pixel rows.

For example, as in FIG. 8, with respect to positions of second mesh patterns MVC disposed in an n^{th} pixel row, a position of each of second mesh patterns MVC disposed in an (n+1)^{th} pixel row can be shifted by a horizontal pitch HP of one subpixel in a right direction.

As in FIG. 9, with respect to the positions of the second mesh patterns MVC disposed in the n^{th} pixel row, the position of each of the second mesh patterns MVC disposed in the (n+1)^{th} pixel row can be shifted by a horizontal pitch HP of one subpixel in a left direction.

The common electrode compensation pattern according to an embodiment of the present disclosure can further include third mesh patterns MVCb which are disposed between adjacent second mesh patterns MVC in the same pixel row and partially overlap the other data lines DL.

In the same pixel row, a length Ly of each of the third mesh patterns MVCb can be formed to be less than a length Lx of each of the second mesh patterns MVC, and thus, a semi-mesh form can be set instead of a full-mesh form.

In the same pixel row, when the length Ly of each of the third mesh patterns MVCb is designed to be 1/3 or less of the length Lx of each of the second mesh patterns MVC, a light reflection effect can decrease in proportion thereto.

A placement configuration, where a position of a common electrode compensation pattern having a semi-mesh form is shifted by a horizontal pitch HP of one subpixel between adjacent pixel rows of pixel areas, will be described below in more detail.

Referring to FIG. 8, in a first pixel row Pixel ROW1, second mesh patterns MVC having the length Lx can overlap data lines DL2, DL5, and DL8. In a second pixel row Pixel ROW2, second mesh patterns MVC having the length Lx can overlap data lines DL3, DL6, and DL9. In a third pixel row Pixel ROW3, second mesh patterns MVC having the length Lx can overlap data lines DL1, DL4, DL7, and DL10.

Referring to FIG. 8, in the first pixel row Pixel ROW1, third mesh patterns MVCb having the length Ly can overlap data lines DL1, DL3, DL4, DL6, DL7, DL9, and DL10. In the second pixel row Pixel ROW2, third mesh patterns MVCb having the length Ly can overlap data lines DL1, DL2, DL4, DL5, DL7, DL8, and DL10. In the third pixel row Pixel ROW3, third mesh patterns MVCb having the length Ly can overlap data lines DL2, DL3, DL5, DL6, DL8, and DL9.

A placement configuration, where a position of a common electrode compensation pattern having a semi-mesh form is shifted by a horizontal pitch HP of one subpixel between adjacent pixel rows of pixel areas, will be described below in more detail.

Referring to FIG. 9, in a first pixel row Pixel ROW1, second mesh patterns MVC having the length Lx can overlap data lines DL3, DL6, and DL9. In a second pixel row Pixel ROW2, second mesh patterns MVC having the length Lx can overlap data lines DL2, DL5, and DL8. In a third pixel row Pixel ROW3, second mesh patterns MVC having the length Lx can overlap data lines DL1, DL4, DL7, and DL10.

Referring to FIG. 9, in the first pixel row Pixel ROW1, third mesh patterns MVCb having the length Ly can overlap data lines DL1, DL2, DL4, DL5, DL7, DL8, and DL10. In the second pixel row Pixel ROW2, third mesh patterns MVCb having the length Ly can overlap data lines DL1, DL3, DL4, DL6, DL7, DL9, and DL10. In the third pixel row Pixel ROW3, third mesh patterns MVCb having the length Ly can overlap data lines DL2, DL3, DL5, DL6, DL8, and DL9.

As described above, when a position of a common electrode compensation pattern having a semi-mesh form is shifted by a horizontal pitch HP of one subpixel between adjacent pixel rows of pixel areas in a right direction or a left direction, as in FIG. 10, a light reflection effect can be offset, and thus, a luminance non-uniformity phenomenon recognized in a vertical band shape can be improved.

Moreover, referring to FIG. 10, a line width of the common electrode compensation pattern can be designed to be less than a line width of each of gate lines GL and data lines DL, and thus, a reduction in an opening region of a subpixel due to the common electrode compensation pattern can be prevented.

Moreover, referring to FIG. 10, a common electrode compensation pattern of a first substrate can be disposed at a position overlapping a black matrix pattern of a second substrate, and thus, a reduction in an opening region of a subpixel due to the common electrode compensation pattern can be prevented.

A shift structure of the common electrode compensation pattern described above can be applied to a structure where subpixels are shifted by units of pixel row and are arranged, so as to implement a 3D image.

In the LCD apparatus according to embodiments of the present disclosure, a common electrode compensation pattern directly contacting a common electrode can be disposed in common at positions overlapping gate lines and data lines, and a position of the common electrode compensation pattern can be shifted by a horizontal pitch of one subpixel between adjacent pixel rows of pixel areas, thereby preventing a fluctuation of a common voltage and solving a picture issue caused by a black vertical band.

The effects according to the present disclosure are not limited to the above examples, and other various effects can be included in the specification.

While the present disclosure has been particularly shown and described with reference to example embodiments thereof, it will be understood by those of ordinary skill in the art that various changes in form and details can be made therein without departing from the spirit and scope of the present disclosure as defined by the following claims.

What is claimed is:

1. A liquid crystal display apparatus comprising:
gate lines and data lines intersecting with each other in a matrix type to define pixel areas, on a first substrate;
a common electrode disposed in the pixel areas;
a common electrode compensation pattern directly contacting the common electrode at positions overlapping at least one of the gate lines and the data lines; and
a pixel electrode disposed on the common electrode compensation pattern,
wherein a position of the common electrode compensation pattern is shifted by a horizontal pitch of one subpixel between adjacent pixel rows of the pixel areas.

2. The liquid crystal display apparatus of claim 1, wherein the common electrode compensation pattern comprises:
first mesh patterns extending in a first direction to overlap the gate lines.

3. The liquid crystal display apparatus of claim 2, wherein the common electrode compensation pattern further comprises:
second mesh patterns extending in a second direction to overlap some of the data lines and connected to the first mesh patterns.

4. The liquid crystal display apparatus of claim 3, wherein positions of the second mesh patterns are shifted by the horizontal pitch of the one subpixel between the adjacent pixel rows.

5. The liquid crystal display apparatus of claim 4, wherein, with respect to positions of the second mesh patterns disposed in an n^{th} pixel row, positions of the second mesh patterns disposed in an (n+1)^{th} pixel row are shifted by the horizontal pitch of the one subpixel in a right direction, where n is a real number.

6. The liquid crystal display apparatus of claim 4, wherein, with respect to positions of the second mesh patterns disposed in an n^{th} pixel row, positions of the second mesh patterns disposed in an (n+1)^{th} pixel row are shifted by the horizontal pitch of the one subpixel in a left direction, where n is a real number.

7. The liquid crystal display apparatus of claim 3, wherein the common electrode compensation pattern further comprises third mesh patterns disposed between adjacent second mesh patterns in a same pixel row and partially overlapping the other data lines.

8. The liquid crystal display apparatus of claim 7, wherein, in a same pixel row, a length of each of the third mesh patterns is less than a length of each of the second mesh patterns.

9. The liquid crystal display apparatus of claim 7, wherein, in a same pixel row, a length of each of the third mesh patterns is 1/3 or less of a length of each of the second mesh patterns.

10. The liquid crystal display apparatus of claim 1, wherein a line width of the common electrode compensation pattern is less than a line width of each of the gate lines and the data lines.

11. The liquid crystal display apparatus of claim 1, wherein the common electrode comprises a transparent conductive material, and
wherein the common electrode compensation pattern comprises an opaque conductive material.

12. The liquid crystal display apparatus of claim 11, wherein the common electrode has a sheet shape covering some of the data lines.

13. The liquid crystal display apparatus of claim 1, further comprising:
a black matrix pattern disposed on a second substrate opposite to the first substrate; and
color filters disposed on the black matrix pattern,
wherein the common electrode compensation pattern is disposed at a position overlapping the black matrix pattern.

14. The liquid crystal display apparatus of claim 9, further comprising a plurality of lenses disposed on a display panel including the first substrate and the second substrate and configured to represent a two-dimensional (2D) image or a three-dimensional (3D) image, based on light incident from the display panel.

15. The liquid crystal display apparatus of claim 14, wherein each of the plurality of lenses is a lenticular lens or a switchable lens.

16. The liquid crystal display apparatus of claim 1, wherein the common electrode compensation pattern directly contacts the common electrode at positions overlapping at least some portion of each of the gate lines and the data lines.

17. The liquid crystal display apparatus of claim 1, further comprising:
a first insulating layer covering the data lines and disposed between the data lines and the common electrode; and
a second insulating layer covering the common electrode compensation pattern, and disposed between the common electrode and the pixel electrode.
